(19) United States
(12) Patent Application Publication
(10) Pub. No.: US 2006/0284780 A1
(43) Pub. Date: Dec. 21, 2006

(54) Dual-band dipole antenna

(76) Inventors: An-Chia Chen, Sioushuei Township (TW); Shih-Huang Yeh, Douliou City (TW)

Correspondence Address: LIN & ASSOCIATES INTELLECTUAL PROPERTY, P.O. BOX 2339, SARATOGA, CA, 95070-0339, US

(21) Appl. No.: 11/187,501

(22) Filed: Jul. 22, 2005

(30) Foreign Application Priority Data
Jun. 17, 2005 (TW) 094120216

(51) Int. Cl. H01Q 9/28

(52) U.S. Cl. 343/795

(57) ABSTRACT

A dual-band dipole antenna is provided with a first conductor arm, a second conductor arm, and a feeding signal line, wherein two conductor arms have different lengths. The feeding signal line has a signal end and a ground end, respectively connected to the feeding points on the two conductor arms. The feeding signal line transmits feeding signals to the two conductor arms through the feeding points, thereby generating two operating modes of the antenna. The desired frequency ratio of a second operating mode and a first operating mode for a dual-band wireless local network is achieved by simply changing the two conductors' relative lengths, so that the frequency ratio of a second operating mode and a first operating mode for the antenna is the same as the desired frequency ratio.

### FIELD OF THE INVENTION

The present invention generally relates to an antenna, and more specifically to a dual-band dipole antenna.

### BACKGROUND OF THE INVENTION

To expand the market acceptance of the notebook computers, all the notebook computer manufactures have built-in wireless local area network (WLAN) installed in the notebook computers. As the WLAN gains popularity, the dual-band WLAN is attracting more attention. However, the dual-band antenna used in the current WLAN application usually suffers the shortcomings of complex structure and low antenna gain.

US. Patent Publication No. 2004/0222936 A1 disclosed a multi-band dipole antenna, which uses a plurality of resonant paths to achieve the dual-band operation.

US. Patent Publication No. 2004/0140941 A1 disclosed a low profile dual frequency dipole antenna structure, which uses a plurality of resonant paths to achieve the dual-band/multi-band operation. The disadvantages are that the characteristics of the high frequency resonate path antenna is prone to the interference of the low frequency path, and the structure is more complex and requires particular ground interface.

U.S. Pat. No. 6,791,506 B2 disclosed a dual-band single-feed dipole antenna and method of making the same, and U.S. Pat. No. 6,624,793 B1 disclosed a dual-band dipole antenna. However, both patents require the use of two pairs of conductor arms of different lengths to generate high frequency antenna mode and low frequency antenna mode, where the long conductor arm generates the low frequency antenna mode and the short conductor arm generates high frequency antenna mode, so that the dual-band operation can be achieved. This type of design is usually more complex than the design using only a single pair of conductor arms. In addition, this type of design usually embeds the short conductor arm inside the long conductor arm, which may lead to the poor performance of the antenna mode generated by the short conductor arm. For example, the US. Patent Publication No. 2004/0222936 A1 described an antenna gain generated by the long conductor arm being 3 dBi, while the antenna gain generated by the short conductor arm being less than 0 dBi.

FIG. 1 shows a schematic view of a conventional dual-band dipole antenna. A dual-band dipole antenna includes two conductor arms 11, 12, and a feeding signal line 14. Two conductor arms 11, 12 have the same length, and are printed on a microwave substrate 13. The exciting method is to use feeding signal line 14 and the feeding locations are feeding points 111, 121 on conductor arms 11, 12.

FIG. 2 shows the measurement of the return loss of the dual-band dipole antenna shown in FIG. 1. As shown in FIG. 2, the antenna has two resonate modes 21, 22, with operating frequency ratio being about 3:1. However, this antenna cannot be used in the dual-band WLAN because the operating frequency ratio between two resonate modes suitable for operating in dual-band WLAN is about 2.14:1; that is, 5250 MHz:2450 MHz.

### SUMMARY OF THE INVENTION

The present invention has been made to overcome the aforementioned drawback of conventional antenna. The primary object of the present invention is to provide a dual-band dipole antenna with a simple structure and using only a single pair of conductor arms. The antenna comprises a first conductor arm, a second conductor arm, and a feeding signal line. The first conductor arm and the second conductor arm have different lengths. The feeding signal line includes a signal end and a ground end, electrically connected to the feeding points of the two conductor arms, respectively.

Through the first feeding point and the second feeding point, the feeding signal line can feed the signal to the first conductor arm and the second conductor arm and excite the operating mode of the antenna.

According to the present invention, by changing the locations of the feeding points on the dipole antenna, the frequency ratio of the two resonate modes of the dual-band dipole antenna can be changed to 2.1:1. Thus, the frequency ratio of the antenna modes can be controlled to meet the requirements of the dual-band wireless products as well dual-band WLAN applications.

The first embodiment of the present invention shows that the frequency ratio of the two resonate modes of the dual-band dipole antenna can meet the required frequency ratio of a dual-band WLAN by adjusting the length ratio of first conductor arm 31 and second conductor arm 32.

The second embodiment of the present invention shows that the angle between the two conductor arms can range between 0-180°, and be bended to minimize the size of the antenna.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a schematic view of a structure of a conventional dual-band dipole antenna.

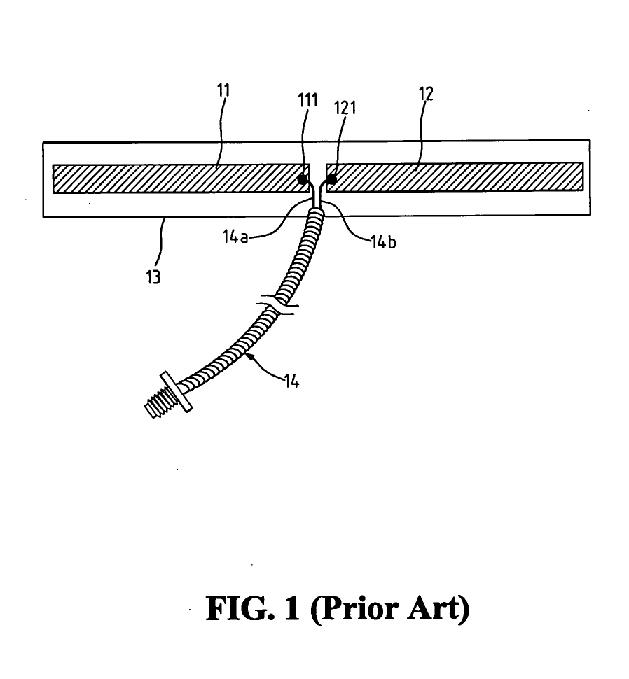

FIG. 2 shows measurement of the return loss of a dual-band dipole antenna shown in FIG. 1.

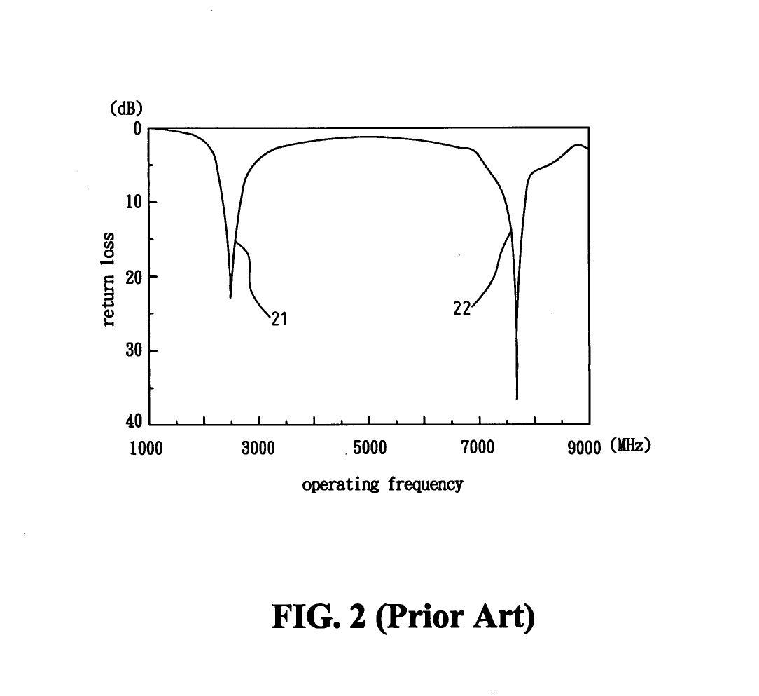

FIG. 3 shows a schematic view of a structure of a first embodiment of a dual-band dipole antenna of the present invention.

FIG. 4 shows measurement of the return loss of the first embodiment of FIG. 3.

FIG. 5 shows an analysis of resonate operating frequency of the antenna of FIG. 1 according the different lengths of the first conductor arm and the second conductor arm.

FIG. 6 shows a schematic view of a structure of a second embodiment of a dual-band dipole antenna of the present invention.

### DETAILED DESCRIPTION OF THE PREFERRED EMBODIMENTS

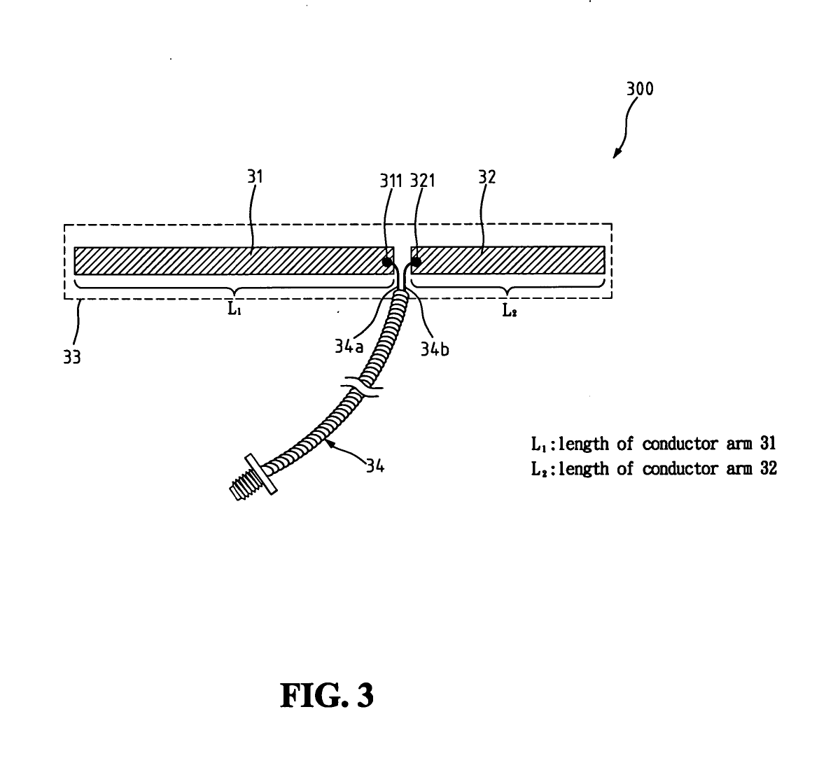

FIG. 3 shows a schematic view of a structure of a first embodiment of a dual-band dipole antenna of the present invention. In this embodiment, a dual-band dipole antenna 300 includes a first conductor arm 31, a second conductor arm 32, and a feeding signal line 34. First conductor arm 31 and second conductor 32 include a first feeding point 311 and a second feeding point 321, respectively. The length L₁ of first conductor arm 31 is greater than the length L₂ of second conductor arm 32. Feeding signal line 34 includes a signal end 34a and a ground end 34b, electrically connected to first feeding point 311 and second feeding point 321, respectively.

Through first feeding point 311 and second feeding point 321, feeding signal line 34 can feed the signal to first conductor arm 31 and second conductor arm 32 and excite the operating mode of the antenna.

According to the present invention, conductor arms 31-32 can be formed on a supporting element, marked 33 as shown in FIG. 3, or formed in the air by a supporting element. Supporting element 33 can be a microwave substrate, and first conductor arm 31 and second conductor arm 32 can both be printed on the microwave substrate. First feeding point 311 can be formed on one end of first conductor arm 31. Similarly, feeding point 321 can be formed on one end of second conductor arm 32.

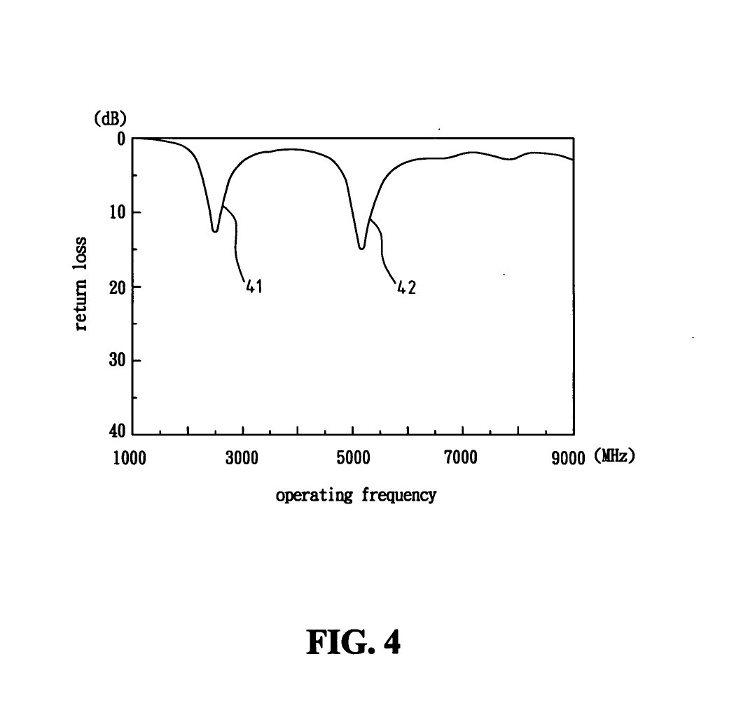

FIG. 4 shows measurement of return loss of the first embodiment of FIG. 3. The x-axis represents the operating frequency (unit: MHz) of the dual-band dipole antenna, and the y-axis represents the return loss (unit: dB) of the dual-band dipole antenna. The embodiment is measured with the following parameters: length L₁ of first conductor arm 31 is 32 mm, length L₂ of second conductor 32 is 13 mm, and microwave substrate 33 is a fiberglass reinforced epoxy resin (FR4) substrate of 0.4 mm in thickness.

As shown in FIG. 4, the operating frequencies of the two resonate modes of this embodiment, first operating mode 41 and second operating mode 42, are 2335 MHz and 5296 MHz, respectively. The ratio between the two operating frequencies (second operating mode:first operating mode) is 2.27:1, which meets the requirement of the current WLAN. The 10 dB bandwidths are 350 MHz and 430 MHz, respectively, which are sufficient to cover the 2.4 GHz and 5.2 GHz bands of the WLAN.

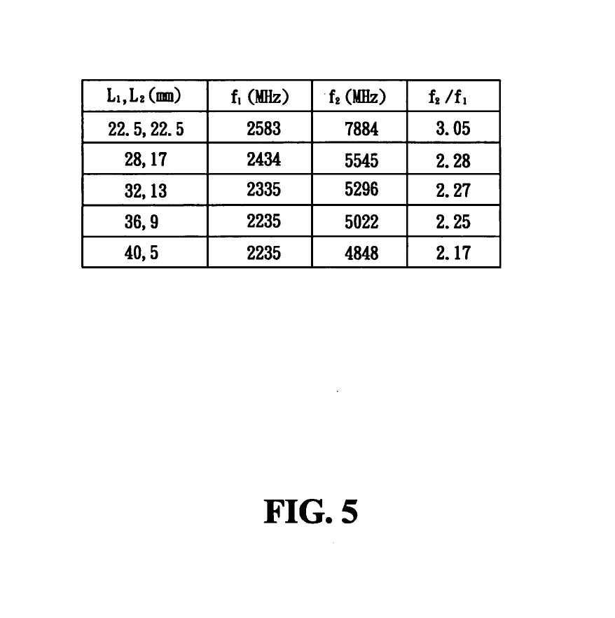

FIG. 5 shows an analysis of resonate frequency of the antenna by varying the lengths of first conductor arm 31 and second conductor arm 32. As shown in FIG. 5, when the sum of the length of first conductor arm 31 and the length of second conductor arm 32 stays fixed, e.g., L₁+L₂=45 mm in this embodiment, first operating frequency f₁ of the first operating mode stays almost unchanged and second operating frequency f₂ of the second operating mode drops rapidly, as the length of first conductor arm 31 increases and the length of second conductor arm 32 decreases.

Therefore, by adjusting the ratio between the length of first conductor arm 31 and the length of second conductor arm 32, a structure with two conductor arms of different lengths can be easily formed, and the required frequency ratio f₂/f₁ for operating in dual-band mode can be easily achieved.

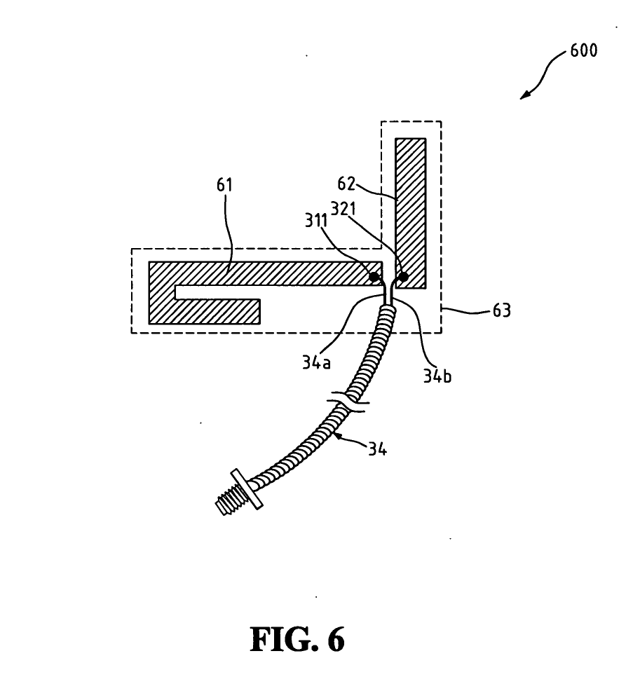

FIG. 6 shows a schematic view of a structure of the second embodiment of the present invention. Dual-band dipole antenna 600 includes a first conductor arm 61 and a second conductor arm 62. The angle between first conductor arm 61 and second conductor arm 62 is between 0-180°. As shown in FIG. 6, first conductor arm 61 and second conductor arm 62 are almost perpendicular. Therefore, the present invention can be placed at the corner of a screen. To reduce the size of the antenna, first conductor arm 61 and second conductor arm 62 can also be bended, as shown in FIG. 6. Second conductor arm 62 and the bended first conductor arm 61 are constructed on a supporting element 63.

In summary, the dual-band dipole antenna of the present invention uses two conductor arms of different lengths to control the operating frequency ratio of the antenna operating modes. In addition, the two conductor arms can be bended to further reduce the size of the antenna.

Although the present invention has been described with reference to the embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A dual-band dipole antenna, comprising:
a first conductor arm having a first feeding point;
a second conductor arm having a second feeding point; and
a feeding signal line having a signal end and a ground end, and electrically connected to said first feeding point and said second feeding point, respectively;
wherein said first and second conductor arms are asymmetric with respect to said feeding signal line for controlling the frequency ratio of two resonate modes of said dual-band dipole antenna.

2. The antenna as claimed in claim 1, wherein said first conductor arm and said second conductor arm are formed on a supporting element.

3. The antenna as claimed in claim 1, wherein the angle between said first conductor arm and said second conductor arm is between 0-180°.

4. The antenna as claimed in claim 1, wherein said first conductor arm is bended.

5. The antenna as claimed in claim 1, wherein said second conductor arm is bended.

6. The antenna as claimed in claim 1, wherein the location of said first feeding point on said first conductor arm is changeable.

7. The antenna as claimed in claim 1, wherein the location of said second feeding point on said second conductor arm is changeable.

8. The antenna as claimed in claim 1, wherein said first feeding point is located at one end of said first conductor arm.

9. The antenna as claimed in claim 1, wherein said second feeding point is located at one end of said second conductor arm.

10. The antenna as claimed in claim 1, wherein said first conductor arm and said second conductor arm are supported in air by a supporting element.

11. The antenna as claimed in claim 2, wherein said supporting element is a microwave substrate.

12. The antenna as claimed in claim 1, wherein said first conductor arm and said second conductor arm have different length.
